(19) United States
(12) Patent Application Publication
(10) Pub. No.: US 2024/0158311 A1
(43) Pub. Date: May 16, 2024

(54) COMPOSITE BODY MADE FROM A REACTION-BONDED MIXED CERAMIC INFILTRATED WITH MOLTEN SILICON

(71) Applicant: Schunk Ingenieurkeramik GmbH, Willich (DE)

(72) Inventors: Lars SCHNETTER, Wimbach (DE); Philipp GINGTER, Monchengladbach (DE); Clara MINAS-PAYAMYAR, Dusseldorf (DE); Fabian HEINZ, Selters (DE)

(73) Assignee: Schunk Ingenieurkeramik GmbH, Willich (DE)

(21) Appl. No.: 17/777,533

(22) PCT Filed: Apr. 16, 2021
(86) PCT No.: PCT/EP2021/059908

§ 371 Date: May 17, 2022

(51) Int. Cl. C04B 41/50; B28B 1/00; C04B 35/565; C04B 41/45

(52) U.S. Cl. CPC C04B 41/5096; B28B 1/001; C04B 35/565; C04B 41/457; C04B 2235/3821; C04B 2235/3826; C04B 2235/428; C04B 2235/5436; C04B 2235/616; C04B 2235/775; C04B 2235/96

(57) ABSTRACT

A shaped composite body of a reaction-bonded, silicon-infiltrated mixed ceramic, the microstructure of which is determined by primary grains of crystalline B₄C grains (1) of mean grain size d50>100 μm and <500 μm and a fraction of >10%, by weight, and <50%, by weight, and by primary grains of a finer silicon carbide with d50<70 μm and a fraction of >10%, by weight, and <50%, by weight, and the primary grains are siliconized (3) bonded by secondarily formed silicon carbide with a fraction of >5%, by weight and <25%, by weight, in a silicon carbide matrix having a free metallic silicon (2) content of >1%, by weight, and <20%, by weight.

The invention relates to a composite body made from a reaction-bonded mixed ceramic infiltrated with molten silicon.

In the field of protective materials for people, vehicles and aircraft, weight plays a decisive role. For this reason, ceramic composite solutions in particular are used as an alternative to steel solutions. Compared to steel, these solutions make it possible to stop ballistic projectiles with a lower overall weight and thus better wearing comfort for the user.

In principle, the focus is on aluminum oxide, silicon carbide, boron carbide in sintered form, and reaction-bonded materials with a metallic content in the matrix. Examples here are reaction-bonded SiC (RBSiC), reaction-bonded B₄C (RB B₄C) and combinations of these materials (RBSiC/B₄C). While silicon carbide and especially boron carbide provide the lightest protection solutions, they also generate the highest costs. For this reason, these materials are preferably used in the field of aircraft protection as well as personal protection. In the field of personal protection/body protection, in particular monolithic (one-piece protective elements) are also used.

For these products, sintered materials typically offer an opportunity for lighter protective elements than those made of the reaction-bonded materials, but in most cases, the reaction-bonded materials offer the better price-performance ratio. For example, RB B₄C can also be successfully used with proportional RBSiC for various threat classes such as NIJ4 and ammunition types with hardened steel cores. These materials dominate the market in Europe but also in Asian countries such as Korea.

From U.S. Pat. No. 8,128,861 B1 it is known, that better protection against ammunition made of hard metal such as WC/Co (tungsten carbide-cobalt) is required in particular for “NEXT Generation SAPI Plates”. As the US defense market is the largest in the world, there is a great interest here for efficient protective materials. In tests against ammunition having tungsten carbide cores, RB B₄C and RBSiC but also sintered B₄C have so far typically performed poorly, which is why mostly sintered silicon carbide is used here and almost no reaction-bonded materials have been used so far.

Even sintered B₄C performs poorly against these types of ammunition due to the high hardness of the penetrator material and the high velocities that cause amorphization of the boron carbide, as described for example in, “High-Velocity Ballistic Impact with Boron Carbide Produces Localized Amorphization May 2011”, MRS Bulletin 28(05).333. This results in a drop in performance as a ballistic material.

Materials of RB B₄C that are typical for the U.S. market and are frequently used against threats without a WC core, are described, for example, in WO 2005/079207 A2. The typical reaction-bonded material available on the U.S. market therefore lacks suitability against the so-called kinetic energy bullets made from WC.

Furthermore, most of the protective materials used have fine grain sizes, such as those described in U.S. Pat. No. 6,609,452. According to the prior art, such materials offer better performance. JP 5914026 B2 as well describes a reaction-bonded boron carbide material, but with a grain size<40 μm for the boron carbide powder.

It is further, known from US 2013/0168905 A1, that coarse primary crystals lead to poorer ballistic performance, since the coarse crystallites condition poorer intercrystalline bonding.

Additionally known, from U.S. Pat. No. 3,857,744, is a silicon-infiltrated boron carbide, which uses a grain size of 600 grit to 120 grit. Typically, therefore, a grain size<110 μm is used. In addition, the B₄C content here is significantly greater than 50%, by weight. However, it has been shown that high B₄C contents lead to poorer performance compared with WC/Co ammunition, since amorphization of the boron carbide takes place.

Finally, it is known from US patent US 2013/0168905 A1 that particle sizes between 200 μm and 40 μm can in principle be used, but that particles>90 μm in particular are screened. In addition, a material with 50-60%, by weight, boron carbide is described there, which has been shown in the past to be disadvantageous compared to tungsten carbide.

It is an object of the invention, therefore, to provide an improved shaped composite body made of a reaction-bonded SiC/B₄C material, which offers an optimized price/performance ratio, and can thereby, also be used against the important tungsten carbide ammunition.

This object is achieved by the features of claim 1.

Provided consequently is a ceramic body, in particular for use as ballistic protection, based on a metal-ceramic composite material comprising Si, SiC and coarse-grained B₄C. The material properties are determined by the raw material formulation, the shaping process, and the siliconizing process. The shaped composite bodies thus produced typically have optimized density, high hardness and are particularly suitable for ballistic protection applications due to the special microstructure.

The microstructure can be influenced, in the case of a reaction-bonded, silicon-infiltrated mixed ceramic material, by the formation of secondary silicon carbide. The type and quantity of any added carbon are decisive for the formation of secondary silicon carbide and thus for the formation of the bonding bridges which determine the material strength. The siliconizing procedure, in which molten silicon penetrates the porous shaped body, is significantly influenced by the pore structure.

Surprisingly it has been found, in ballistics tests with the shaped composite body of the invention, that comparatively good performance is given by reaction-bonded (RB) B₄C with primary crystals B₄C>100 μm and B₄C fractions<50%, by weight, embedded in a matrix of fine-grained SiC composed of primary and secondary SiC fractions. Surprisingly, the large B₄C grains in combination with a not too high content prevent amorphization, with the SiC matrix stabilizing. The selected size of the primary grains of B₄C also has a stabilizing effect with the SiC matrix. These are material properties for which there has been no indication in the prior art.

Finally, by controlling the amount of carbon added, it is possible to influence the formation of secondary silicon carbide and the binding bridges generated as a result. According to the invention, it has been shown that preferably a smaller amount of SiC formed during infiltration, for example of >5%, by weight, and <25%, by weight, and a Si content<20%, by weight, is advantageous. The material thus appears to form a kind of functional deformability at the level of B₄C, in a ceramic that is hardly deformable per se.

A low Si content as well as a higher SiC content can be advantageous. Particularly advantageous is a remaining Si content<15%, per weight. A material with a B₄C content between 30-40%, by weight, a secondary SiC content of 15-25%, by weight, and an Si content<15%, by weight, and a primary particle size of the B₄C>100 μm is particularly preferred.

For the shaping, all usual processes can be used. For simple geometries of limited size, such as body protection plates, for example, casting and, in particular, pressure slip casting are the most efficient production techniques. It should be noted that the coarse crystallites of B₄C tend to settle. Regardless of this, a sedimentation-stable slip can be produced.

Particularly in the case of high wall thicknesses>10 mm and very large dimensions, slip casting reaches its limits here, as cracks and large-area deformation can occur more frequently. This also applies to isostatically pressed material, since the density gradients also increase with size and volume during isostatic pressing.

Surprisingly, powder bed-based 3D printing has emerged as a suitable manufacturing technique for very large components. Especially for the material according to the invention—coarse B₄C combined with fine SiC—powder bed printing is a very efficient manufacturing method. The large dimensions are required in particular in the aerospace sector, for example as protective components for seats or even large panels.

The coarse crystallites of B₄C clearly offer, on the one hand, the advantage of high efficiency in printing, and on the other hand, surprisingly, it has been found that the large components produced in this way are significantly more homogeneous than products manufactured via casting, die casting or isostatic pressing. Compared with isostatic pressing and subsequent green machining, powder bed printing also offers considerable cost advantages, since no machining (milling of the green body) is necessary and significant less material has to be used.

For example, 3D powder bed printing makes it possible to produce large components such as seat shells and backrests from the shaped composite body according to the invention. Due to the near-net-shape approach, these components offer not only material saving but also additional opportunities for weight saving, since material only has to be used where it is actually required according to the application.

Protective panels manufactured in this way can easily assume dimensions of 1 m² and more, so that entire protective elements such as doors, tailgates, floor elements and other structural components of a vehicle or aircraft can be manufactured from a single structure. The large elements facilitate integration and avoid joints that can otherwise be weak points in the bombardment. Thus, it is known that in triple points (the point where three corners of ballistic tile meet) ballistic performance decreases by up to 30%. However, due to the high homogeneity of the material resulting from 3D printing, however, very large components with an envelope volume>200×200×200 mm³ or even large areas>500×500 mm² can be realized without any problems.

Further embodiments of the invention can be found in the following description and in the dependent claims.

The invention is explained in more detail below with reference to exemplary embodiments.

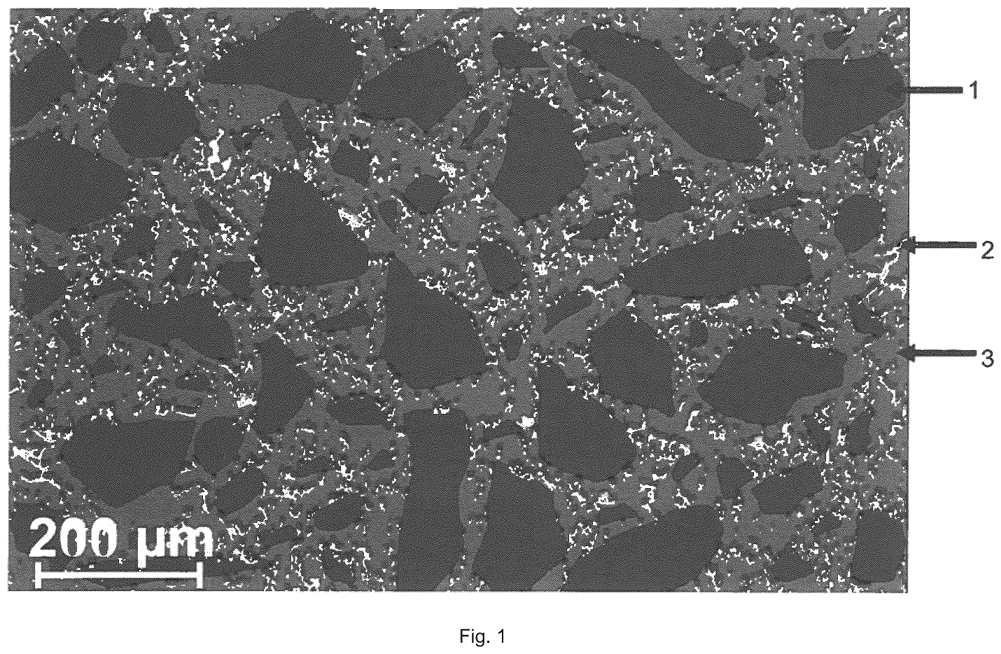

FIG. 1 schematically shows a section of a microstructure.

The invention relates to a shaped composite body composed of a reaction-bonded, silicon-infiltrated mixed ceramic, the microstructure of which is determined by primary grains of crystalline B₄C grains of average grain size d50>100 μm and <500 μm and a content of >10%, by weight, and <50%, by weight. The microstructure is further determined by primary grains of silicon carbide with d50<70 μm and a content of >10%, by weight, and <50%, by weight. The primary grains are silicized bonded by secondarily formed silicon carbide with a content of >5%, by weight, and <25%, by weight, in a silicon carbide matrix having a content of free metallic silicon of >1%, by weight, and <20%, by weight. FIG. 1 shows an example of a microstructure according to the invention. The wt % figures are percentages by weight. Content stands for proportion and/or fraction of a graining.

The invention thus relates to a reaction-bonded SiC/B₄C having a B₄C content <50%, by weight, and a mean particle size (d50) of the boron carbide>100 μm, with a secondary SiC content<25%, by weight, and a metallic Si content<20%, by weight.

Preferably, the content of secondary SiC is between 15%, by weight, and 25%, by weight. A stable support matrix for the primary crystals B₄C and SiC can thus be created, and thus the resistance to, for example, projectiles can be strengthened.

Particularly preferred is a shaped composite body having a B₄C content between 30%, by weight, and 40%, by weight, and an Si content<15%, by weight, and a primary particle size of the B₄C>200 μm.

It is further particularly preferred that the primary grains included to be of silicon carbide with d50<40 μm, more particularly <10 μm. The density gradient may be <2%. The shaped composite body may further contain boron dissolved within the metallic silicon in an amount between >0.05 and <5%, by weight.

The microstructure of FIG. 1 shows the B₄C content as primary grains 1, free metallic silicon 2 and a penetration composite of fine-grained primary and secondary silicon carbide 3.

The shaped composite body can be manufactured via pressure slip casting, which involves the preparation of a slip containing SiC/B₄C particles as well as colloidal carbon and organic auxiliary substances. The resulting green body, is then contacted with liquid silicon and infiltrated at temperatures between 1500° C.-1700° C. During this process, the silicon reacts with the carbon to form secondary SiC.

In another embodiment of the invention, the shaping takes place by 3D printing, as this allows the realization of complex products, such as seat shells and backrests, for aerospace applications. The ceramics produced in this way, in combination with polymers (PE, aramid, etc.) as well as carbon fibers, glass fibers and/or metals, offer particularly efficient protection against WC/Co ammunition, especially against the M993 and M995 ammunition types.

It is a further object of the invention to use of the shaped composite body as ballistic protection. For this purpose, the shaped composite body is preferably coated with one or more layers of a backing material. For example, at least one layer of a backing material may be compressed with the mixed ceramic according to the invention. The backing material may further preferably be formed of several layers of one or more plastics, for example polyethylene, aramid, etc., carbon fibers, glass fibers, metal, for examples aluminum, steel, etc., combination of these materials and/or bonding material, for example adhesive foils.

Various application examples are described below:
1. Production of a body protection plate from the shape composite body according to the invention, for which purpose a pressure slip casting is used. First, an aqueous suspension is prepared consisting of colloidal carbon with a mean particle size of less than 1 μm at a content of 10%, by weight, fine-grained silicon carbide with a mean particle size of 5-10 μm at a content of 50%, by weight, and coarse-grained B₄C with a mean particle size of 120 μm at a content of 40%, by weight. For this purpose, 18%, by weight, water and 1%, by weight, organic auxiliary substances (wetting agents, fluidizing assistants, binders) are taken into account per 100%, per weight, solids. The slip is then cast on a die casting machine, using a porous plastic mold based on polymethyl methacrylate at a slip pressure of 40 bar, to form a multi-curved plate having dimensions of 350×275×9 mm. The thus formed shard is then dried in a circulating air drying chamber and converted via a reaction firing to a ceramic plate based on a reaction-bonded composite material consisting essentially of SiC and B₄C as well as free Si. The resulting shaped composite body forms a body protection plate that can be used as a monolithic insert of a ballistic body protection vest. For this purpose, the shaped composite body consists, for example, of an obtained material comprising coarse-grain B₄C with a content of 31%, by weight, fine-grained primary SiC with a content of 41%, by weight, fine-grained secondary SiC with a content of 17%, by weight, and free, metallic silicon with a content of 11%, by weight.
2. Production of a vehicle protection panel from the shaped composite body according to the invention, for which uniaxial press molding is used. First of all an aqueous suspension is prepared according to the composition described in Example 1, and further processed into a press granulate by means of a spray-drying process. Only the composition of the organic auxiliaries has to be adjusted and a pressing aid added. The granules are then filled into a square hard metal mold and pressed at a pressure of 1700 bar. The blank thus obtained is then subjected to reaction firing, to produce a ceramic plate based on a reaction-bonded composite material, consisting substantially of SiC and B₄C as well as free Si, the latter having an edge length of 50 mm and a wall thickness of 9 mm. The shaped composite body thus obtained forms a polygonal protective plate that can be used for the efficient lining of large areas in vehicle protection.
3. Production of a helmet from the shaped composite body according to the invention, for which a 3D printing process is used. The shape is built up layer by layer from a shapeless graining consisting of SiC and B₄C, in a mixing ratio of 70%, by weight, SiC and 30%, by weight, B₄C, the B₄C powder being based, for example, on a grain size distribution known from an industrial refractory ceramic under the designation 100/F and thus having characteristic values of d10=75 μm, d50=115 μm and d90=160 μm. The finer-grained SiC powder is based, for example, on a grain size distribution known for an industrial appraisal grain under the designation F180 and thus has an average particle size d50=65 μm. The selective consolidation of the grains takes place at the locations specified by a CAD model used as a basis, by the dropwise introduction of an organic binder, preferably furan resin, which is applied via inkjet print heads. The CAD model used here, which corresponds to the final component geometry, permits the generation of complexly shaped structures. Following these two sub-steps, the construction plane is lowered by a predefined layer thickness, which in this case is 300 μm. This sequence of steps is repeated iteratively until the layer-by-layer construction of the CAD model is concluded. The complex-shaped pre-body obtained in this way has a porosity of 45% by volume and is then infiltrated with an aqueous dispersion consisting of 30%, by weight, colloidal carbon as well as a dispersing aid and a wetting agent. After a first impregnation process, a complex-shaped ceramic preform is obtained in this way, consisting 87%, by weight, of the original SiC—B₄C powder mixture and 13%, by weight, of colloidal carbon. After a drying process and a possible second impregnation step, this ratio changes to become 79/21%, by weight, and to become 76/24%, by weight, after a possible third impregnation step. After a final drying process, the complex-shaped preform obtained in this way, is converted via reaction firing into a ceramic body based on a reaction-bonded composite material consisting essentially of SiC and B₄C plus free Si. The material thus obtained consists, for example, of coarse-grain B₄C with a content of 15%, by weight, fine-grained primary SiC with a content of 45%, by weight, fine-grained secondary SiC with a content of 24%, by weight, and free, metallic Si with a content of 15%, by weight. The complexly shaped preform obtained in this way can be used as the basic element of a ballistic helmet for head protection, with production via of the 3D printing process described here allowing the creation of an ergonomic, potentially individualized helmet geometry.
4. Production of a seat shell from the shaped composite body according to the invention by means of 3D printing. As described in the previously described example, a powder bed-based 3D printing process is carried out, whereby the mixing ratio in this case is 60%, by weight, SiC and 40%, by weight, B₄C. This leads to a reduction in the resultant density of the fired component, which is why the production of such material compositions is particularly suitable for the aerospace sector. The material obtained in this way consists, for example, of coarse-grained B₄C with a content of 21%, by weight, fine-grained primary SiC with a content of 40%, by weight, fine-grained secondary SiC with a content of 24%, by weight, and free, metallic silicon with a content of 15%, by weight. In this embodiment, using appropriate CAD models, weight-optimized seat shells can be obtained in this way for use in various aircraft, such as helicopters. The seat shell thus produced has a size of around 300×300 mm, a wall thickness of 9 mm and a height of 200 mm, and is ergonomically shaped. The associated backrest has a length of 500 mm, a width of 300 mm and a height of 100 mm, and is likewise ergonomically shaped. Such large components can be manufactured without cracks. Machining via subtractive processes is no longer necessary.
5. Production of an aerospace protection panel from the shaped composite body according to the invention by means of 3D printing. As described above, a powder bed-based 3D printing process is used to produce the shaped composite body according to the invention, in which case the mixing ratio is 50%, by weight, SiC and 50%, by weight, B₄C. The material obtained in this way consists, for example, of coarse-grained B₄C with a content of 26%, by weight, fine-grained primary SiC with a content of 35%, by weight, fine-grained secondary SiC with a content of 24%, by weight, and free, metallic silicon with a content of 15%, by weight. This leads to a further reduction in the resulting density of the fired component, which is why the production of such material compositions is particularly suitable for the aerospace sector, and here more particularly for large-volume elements, such as aerospace protection panels. The side element produced in this way has dimensions of 1200 mm×800 mm×9 mm, for example.
6. Production of a ballistic protection, in particular against an ammunition system with a tungsten carbide core, from the shaped composite body according to the invention, with, for example, a weight per unit area of 2075 g/700 cm²=33.5 kg/m, comprising the mixed ceramic infiltrated with silicon in, for example, a format of 240 mm×305 mm×9.1 mm, 1790 g, with a backing, for example, which preferably has 27 layers of polyethylene and preferably 8 layers of carbon fibers, with, for example, a weight per unit area of 385 g. The mixed ceramic and the backing may be compressed together under temperature and pressure, and preferably in an autoclave. The result is a ballistic protection against 1 shot of 5.56×45 M995 with tungsten carbide core. Protection in this respect means no penetration by the bullet with a backface deformation of 39 mm in the test. In general, the backing can be made of aramid fiber layings, polyethylene (PE), carbon fiber layings, glass fiber layings and/or a mixture thereof. Furthermore, the backing can preferably be attached to the mixed ceramic on one or both sides. Generally speaking, therefore, 1 shot of M995 with tungsten carbide core can preferably be stopped at a basis weight of <32 kg/m².
7. Production of a ballistic protection, in particular against an ammunition system with tungsten carbide core, from the shaped composite body according to the invention, with, for example, a weight per unit area of 2342 g/700 cm²=33.5 kg/m, comprising the mixed ceramic infiltrated with silicon in, for example, a format of 240 mm×305 mm×9.1 mm, 1792 g, with a backing, for example, which has preferably 39 layers of polyethylene and preferably 8 layers of carbon fibers, with a weight per unit area, for example, of 550 g. The mixed ceramic and the backing may be compressed together under temperature and pressure, and preferably in an autoclave. The result is a ballistic protection against 2-shots of 5.56×45 M995 with tungsten carbide core. Protection in this respect means no penetration by the bullet with a backface deformation of 29 mm on the 1^{st} shot and 37 mm in the 2^{nd} shot in the test. The backing can generally be made of aramid fiber layings, polyethylene (PE), carbon fiber layings, glass fiber layings and/or a mixture thereof. The backing, furthermore, can preferably be attached to one side or both sides of the mixed ceramic. In general, therefore, 2 shots of M995 with tungsten carbide core at a distance of 100 mm can be preferably stopped for a basis weight of preferably <40 kg/m².

1. A shaped composite body of a reaction-bonded, silicon-infiltrated mixed ceramic, the microstructure of which is determined by primary grains of crystalline B₄C grains (1) of mean grain size d50>100 μm and <500 μm and a fraction of >10%, by weight, and <50%, by weight, and by primary grains of a finer silicon carbide with d50<70 μm and a fraction of >10%, by weight, and <50%, by weight, and the primary grains are siliconized (3) bonded by secondarily formed silicon carbide with a fraction of >5%, by weight, and <25%, by weight, in a silicon carbide matrix with a content of free metallic silicon (2) of >1%, by weight, and <20%, by weight.

2. The shaped composite body as claimed in claim 1, wherein the primary grains are siliconized bonded by secondarily formed silicon carbide with a fraction of >15%, by weight, and <25%, by weight.

3. The shaped composite body as claimed in claim 1, wherein the primary grains contained are of silicon carbide with d50<40 μm, more particularly <10 μm.

4. The shaped composite body as claimed in claim 1, wherein the density gradient is <2%, by weight.

5. The shaped composite body as claimed in claim 1, wherein the dissolved boron is contained within the free metallic silicon (2) in a proportion between >0.05 and <5%, by weight.

6. The shaped composite body as claimed in claim 1, wherein the shaping may be carried out by slip casting, pressure casting, uniaxial pressing, isostatic pressing, stamping or manual powder compaction.

7. The shaped composite body as claimed in claim 1, wherein the shaping may be carried out via a powder bed 3D printing process.

8. The shaped composite body as claimed in claim 7, wherein a mixture of SiC and B₄C powder is built up by means of binder by powder bed printing to give a three-dimensional component and is subsequently siliconized.

9. The shaped composite body as claimed in claim 1, wherein the shaping takes place in plate form.

10. The shaped composite body as claimed in claim 1, wherein the shaping is performed with an envelope volume>200×200×200 mm.

11. The use of the shaped composite body as claimed in claim 1 as ballistic protection, wherein a backing material composed of one or more layers is provided, which is compressed with the mixed ceramic material to a basis weight<32 kg/m² or <40 kg/m² for selectable ballistic protection against one shot or multiple shots of an ammunition system.

12. The use of the shaped composite body as claimed in claim 11, wherein the backing material is designed for protection against ammunition containing tungsten or tungsten carbide.

13. The use of the shaped composite body as claimed in claim 11, wherein the backing material is made of at least one layer of one or more plastics, more particularly polyethylene or aramid, carbon fibers, glass fibers, metals and/or a combination of these materials and/or bonding material, more particularly adhesive foils.

14. The use of the shaped composite body as claimed in claim 11, wherein the shaping is provided for producing body protection panels, seat shells, backrests and combinations thereof and panels in aerospace protection.
